(19) United States
(12) Patent Application Publication
(10) Pub. No.: US 2004/0008188 A1
(43) Pub. Date: Jan. 15, 2004

(54) Power saving mechanism for cordless electronic device

(75) Inventor: Ching-Chiang Liu, Taipei (TW)

Correspondence Address: BACON & THOMAS, PLLC, 625 SLATERS LANE, FOURTH FLOOR, ALEXANDRIA, VA, 22314

(73) Assignee: GLOBLINK TECHNOLOGY INC., Taipei (TW)

(21) Appl. No.: 10/337,399

(22) Filed: Jan. 7, 2003

(30) Foreign Application Priority Data
Jul. 11, 2002 (TW) 091217870

(51) Int. Cl. G09G 5/00

(52) U.S. Cl. 345/177

(57) ABSTRACT

The present invention relates a power saving mechanism in a cordless electronic device comprising a vibration sensor on a circuit board thereof having one end electrically coupled to an input pin of microprocessor on the circuit board and the other end electrically coupled to power supply of the circuit board. While the electronic device is inactive in a power saving mode, the electronic device can be activated through vibrating the electronic device, which enables the vibration sensor to be closed and the current of power supply to be supplied to the input pin via the vibration sensor to activate the microprocessor to change its logic level and activate all electronic components of the circuit board.

### FIELD OF THE INVENTION

The present invention relates to power saving devices and more particularly to an improved power saving device for a cordless, optical mouse.

### BACKGROUND OF THE INVENTION

Recently, a variety of electronic products are constantly available as powerful electronic components are developed by implementing advanced manufacturing technology due to continuous progress in electronics and material science. As a result, manufacturing cost of electronic products is greatly reduced. Also, features and quality of electronic products are greatly improved. Moreover, typical electrical elements such as vacuum tubes are replaced by various miniaturized semiconductor devices as semiconductor industry continuously makes progress. Currently, the trend of electronic products is lightweight, compact, and portable. This in turn increases convenience in use and popularity among vast consumers about the electronic products. For example, many high performance, low price electronic products (e.g., cordless, optical mice) are affordable by general consumers. It is typical that one or more cells are used as power of an electronic/electrical device such as flashlight, electric razor, cordless mouse, PDA (Personal Digital Assistant), cordless keyboard, or cordless joystick. However, a number of disadvantages associated with cell(s) of the battery-operated device have been found. For example, power consumption of a cell is significant, resulting in a shortening of useful life thereof. Also, dead cells can cause pollution to the environment. Moreover, cost for operating such device is relatively high. Thus, it is desirable among manufacturers to develop a power saving device associated with cell(s) mounted in an electronic/electrical product.

A conventional cordless, optical mouse having an embedded power saving mechanism is shown in FIG. 1. Such power saving mechanism, as designed, aims at reducing power consumption of a cell by putting mouse in a power saving mode after a predetermined period of inactivity has passed. In detail, a microprocessor 11 within the mouse 10 will activate other components of the mouse 10 to enter into the power saving mode after a predetermined period of inactivity has passed (i.e., no movement of mouse). At the same time, a light-emitter 13 of the mouse 10 powered by one or more cells may intermittently emit light pulses. As such, a photosensor 15 of the mouse 10 can receive the reflected light pulses as the mouse 10 moves. In turn, the microprocessor 11 is activated by the light-emitter 13. Finally, all components of the mouse 10 enter into an operating mode as commanded by the microprocessor 11. However, a not so small amount of cell power can be consumed even light pulses are emitted intermittently by the light-emitter 13. Interval from starting to stopping of the emission of light pulses must be increased significantly in order to effectively reduced the power consumption of cell. For example, a frequency of light pulses emitted by the light-emitter 13 is reduced from 120 times per second to 10 times per second. It is advantageous for saving power of the light-emitter 13 and thus cell(s) while it is disadvantageous for adversely affecting a sensitivity of detecting movement of the mouse 10, resulting in a delay of waking up the mouse 10. This is inconvenient for user. Hence, a need exists for an improved, more effective power saving mechanism.

### SUMMARY OF THE INVENTION

A primary object of the present invention is to provide a power saving mechanism incorporated in a cordless electronic device (e.g., cordless, optical mouse). The power saving mechanism comprises a vibration sensor on a circuit board of the electronic device. The vibration sensor has one end electrically coupled to an input pin of microprocessor on the circuit board and the other end electrically coupled to power supply of the circuit board. After a predetermined period of inactivity of the mouse and open condition of the vibration sensor, the electronic device will enter into a power saving mode and be inactive. However, the vibration sensor will be closed through vibrating the electronic device for causing the electronic device entering into an operating mode. In response, the current of the power supply is supplied to the input pin via the vibration sensor to activate the microprocessor in order to change its logic level, and all electronic components of the circuit board are activated to enter into an operating mode. In such a manner, a wakeup circuit consisting of the vibration sensor, the power supply, and the input pin of the microprocessor is able to command the electronic device to enter into the power saving mode in which all power consumption components are disabled while only the power supply and the input pin are enabled with a minimum power consumption. By utilizing this, the purpose of effectively saving power of the inactive electronic device is obtained.

The above and other objects, features and advantages of the present invention will become apparent from the following detailed description taken with the accompanying drawings.

### BRIEF DESCRIPTION OF THE DRAWINGS

FIG. 1 is a partial cut-away side view of a conventional cordless, optical mouse having a power saving mechanism;

FIG. 2 is a partial cut-away side view of a cordless, optical mouse having a power saving mechanism according to the invention;

FIG. 3 is a schematic circuit diagram of a first preferred embodiment of a power saving circuit consisting of power supply, microprocessor and vibration sensor of the mouse;

FIG. 4 is a schematic circuit diagram of a second preferred embodiment of a power saving circuit consisting of power supply, microprocessor, and vibration sensor of the mouse and ground;

FIG. 5 is a cross-sectional view of the vibration sensor which is open;

FIG. 6 is a view similar to FIG. 5 in which the vibration sensor is closed; and

FIG. 7 is a partially cut-away perspective view of the mouse for showing its details.

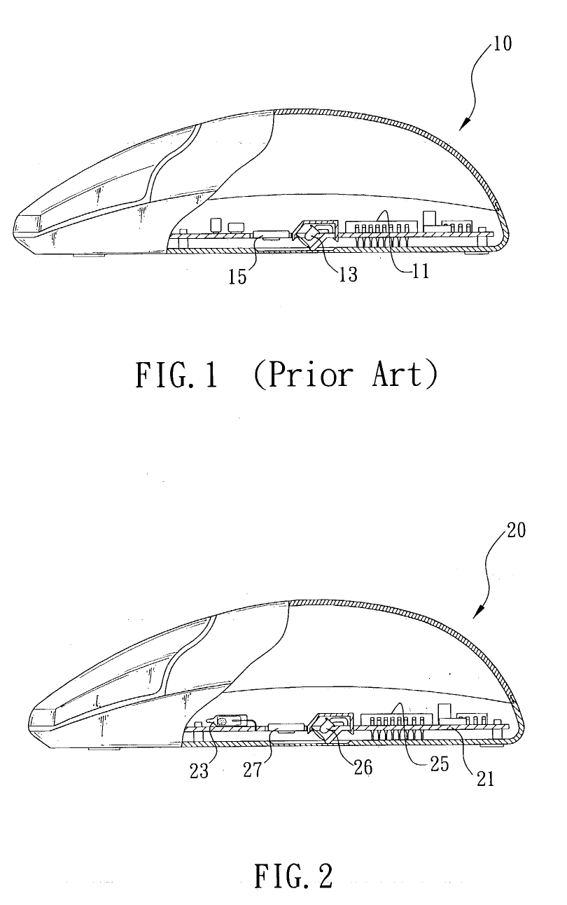

### DETAILED DESCRIPTION OF THE PREFERRED EMBODIMENTS

The invention is directed to a power saving mechanism incorporated in a cordless electronic device (e.g., cordless, optical mouse). The power saving mechanism comprises a vibration sensor on a circuit board of the electronic device. The vibration sensor has one end electrically coupled to an input pin of microprocessor on the circuit board and the other end electrically coupled to power supply of the circuit board. After a predetermined period of inactivity of the electronic device and open condition of the vibration sensor, the electronic device will enter into a power saving mode and turn to be inactive. However, the vibration sensor will be closed through vibrating the electronic device for causing the electronic device to enter into an operating mode. In response, the current of power supply is supplied to the input pin via the vibration sensor to activate the microprocessor in order to change its logic level, and all electronic components of the circuit board are activated to enter into an operating mode. In such a manner, a wakeup circuit consisting of the vibration sensor, the power supply, and the input pin of the microprocessor is able to command the electronic device to enter into the power saving mode in which all power consumption components are disabled while only the power supply and the input pin are enabled with a minimum power consumption. As a result, the purpose of effectively saving power of the inactive electronic device is obtained.

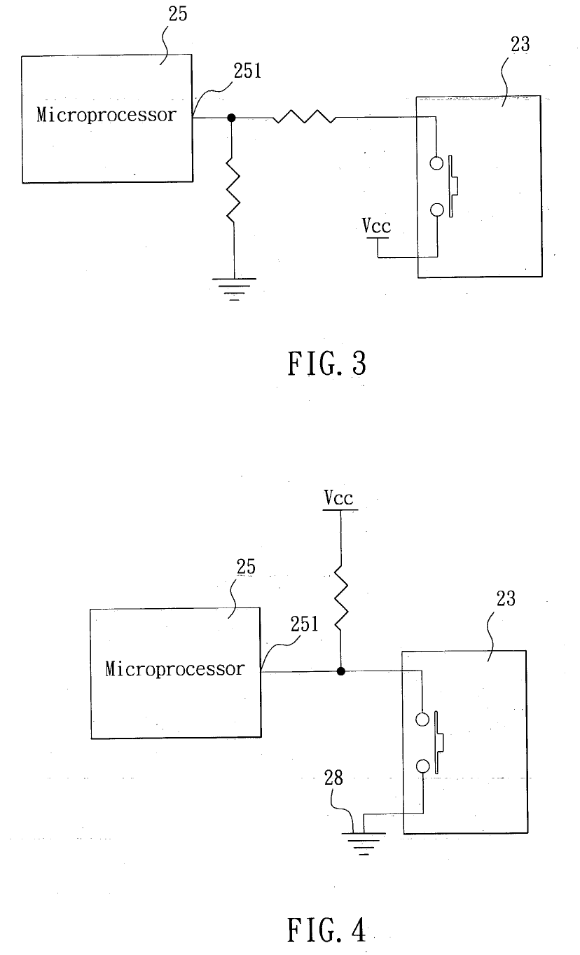

Referring is now made to both FIG. 2 in which a cordless, optical mouse 20 having a power saving mechanism in accordance with the invention is shown and FIG. 3 in which a first preferred embodiment of a power saving circuit is illustrated. As shown, the power saving mechanism comprises a vibration sensor 23 (e.g., mercury switch or magnetic switch) on a circuit board 21 of the mouse 20. The vibration sensor 23 has one end electrically coupled to an input pin 251 of microprocessor 25 on the circuit board 21 and the other end electrically coupled to a power supply Vcc of the circuit board 21. On the circuit board 21 of the mouse 20, there are further provided a light-emitter 26 and a photosensor 27 both electrically coupled to the microprocessor 25 respectively. The light-emitter 26 is able to intermittently emit light pulses. As such, the photosensor 27 is able to receive the light pulses reflected from a planar surface on which the mouse 20 is being manipulated. In response, the microprocessor 25 is able to calculate a direction and a distance of the movement of the mouse 20. Associated data is then sent to a computer electrically coupled to the mouse 20 for processing. A corresponding action such as movement of cursor is thus effected in response to the processing.

Referring to FIGS. 2 and 3 again, after a predetermined period of inactivity of the mouse 20 and open condition of the vibration sensor 23, the mouse 20 will enter into a power saving mode and be inactive. In order to activate the mouse 20, user can vibrate the mouse 20 in order to cause the vibration sensor 23 to be closed and enable the current of the power supply Vcc to be supplied to the input pin 251 via the vibration sensor 23 to activate the microprocessor 25 changing its logic level to a logic high level for activation, and activate all electronic components of the circuit board 21 to enter into an operating mode. In such a manner, a wakeup circuit consisting of the vibration sensor 23, the power supply Vcc, and the input pin 251 of the microprocessor 25 is able to command the mouse 20 to enter into the power saving mode in which all power consumption components including the light-emitter 26 and the photosensor 27 are disabled while only the power supply Vcc and the input pin 251 are enabled with a minimum power consumption. As a result, the purpose of effectively saving power of the inactive mouse is obtained.

Referring is now made to FIG. 4 in which a second preferred embodiment of a power saving circuit is illustrated in conjunction with FIG. 2. As shown, the vibration sensor 23 has one end electrically coupled to the input pin 251 of the microprocessor 25 on the circuit board 21 and the power supply Vcc of the circuit board 21 respectively and the other end being ground 28 indicated at . In a normal operating mode, current of the power supply Vcc is continuously supplied to the input pin 251 for maintaining the input pin 251 at a logic high level. After a predetermined period of inactivity of the mouse 20, the mouse 20 will enter into a power saving mode and be inactive. In order to activate the mouse 20, user can vibrate the mouse 20 to cause the vibration sensor 23 to be closed and enter into an operating mode. In response, the current of the power supply Vcc is diverted to supply to the ground 28 via the vibration sensor 23. As a result, logic level of the input pin 251 goes to logic low. This in turn activates the microprocessor 25. As an end, all electronic components of the circuit board 21 are activated to enter into an operating mode. In such a manner, a wakeup circuit consisting of the vibration sensor 23, the power supply Vcc, the input pin 251 of the microprocessor 25, and the ground 28 is able to command the mouse 20 to enter into the power saving mode in which all power consumption components including the light-emitter 26 and the photosensor 27 are disabled while only the power supply Vcc and the input pin 251 are enabled with a minimum power consumption. As a result, the purpose of effectively saving power of the inactive mouse is obtained.

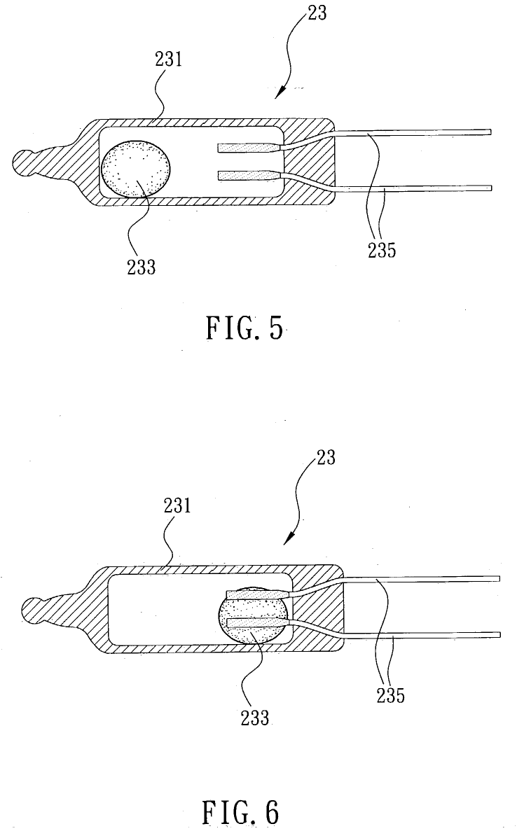

Referring to FIG. 5, the vibration sensor 23 is implemented as a mercury switch having a hollow, transparent body 231 with a drop of mercury 233 filled therein. A pair of pins 235 are formed within the body 231 and extended therefrom to be electrically coupled to two intermediate ends of the power saving circuit. In the position of FIG. 5, the drop of mercury 233 does not contact the pins 235 which means the mercury switch is in an open condition. Referring to FIG. 6, there is shown that the drop of mercury 233 contacts the pins 235 to form a circuit therethrough. In other words, the mercury switch is closed.

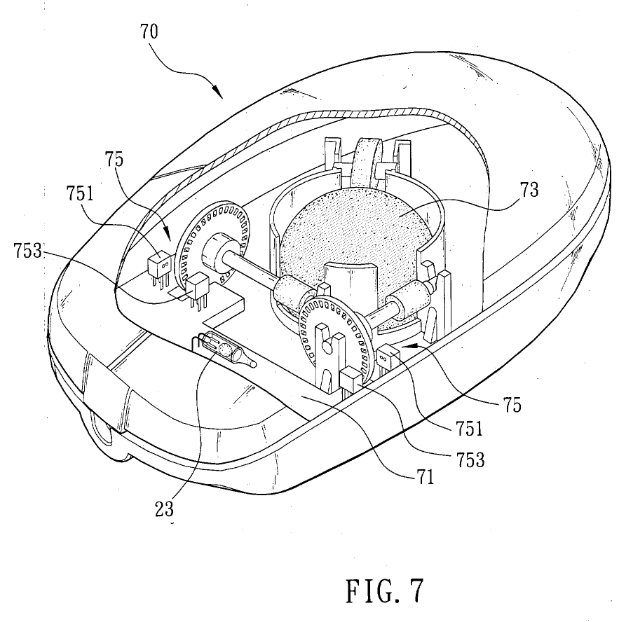

Referring to FIG. 7, there is shown a partially cut-away perspective view of a cordless mouse 70. It is shown that the vibration sensor 23 is provided on a circuit board 71 of the mouse 70. The vibration sensor 23 has one end electrically coupled to an input pin of microprocessor on the circuit board 71 and the other end electrically coupled to power supply of the circuit board 71. A grating device 75 is activated in response to the movement of a ball 73. Hence, a direction and a distance of the movement of the mouse 70 are obtained. Associated data is then sent to a computer electrically coupled to the mouse 70 for processing. A corresponding action such as movement of cursor is thus effected in response to the processing.

Referring to FIG. 3 FIG. 4 and FIG. 7 again, after a predetermined period of inactivity of the mouse 70 and open, condition of the vibration sensor 23, the mouse 70 will enter into a power saving mode and be inactive. In order to activate the mouse 70, user can vibrate the mouse 70 in order to cause the vibration sensor 23 to be closed and enter into an operating mode. In response, current of the power supply is supplied to the input pin 251 via the vibration sensor 23 to activate the microprocessor 25 in order to change its logic level to a logic high level for activation, and all electronic components of the circuit board 71 are activated to enter into an operating mode. In such a manner, a wakeup circuit consisting of the vibration sensor 23, the power supply Vcc, and the input pin 251 of the microprocessor 25 is able to command the mouse 70 to enter into the power saving mode in which all power consumption components including light-emitter 751 and photosensor 753 of the grating device 75 are disabled while only the power supply and the input pin 251 are enabled with a minimum power consumption. As a result, the purpose of effectively saving power of an inactive mouse is obtained.

While the invention has been described by means of specific embodiments, numerous modifications and variations could be made thereto by those skilled in the art without departing from the scope and spirit of the invention set forth in the claims.

What is claimed is:

1. A power saving mechanism for a cordless electronic device comprising:
a vibration sensor located on a circuit board of the electronic device, the vibration sensor having one end electrically coupled to an input pin of a microprocessor on the circuit board and the other end electrically coupled to a power supply of the circuit board,
wherein, after a predetermined period of inactivity of the electronic device and open condition of the vibration sensor, the electronic device enters into a power saving mode and is inactive; while the electronic device is vibrated, the vibration sensor is closed for causing the electronic device to enter into an operating mode, in response, current of the power supply is supplied to the input pin via the vibration sensor to activate the microprocessor for changing its logic level for activation, and thereby activate all electronic components of the circuit board to enter into an operating mode.

2. The power saving mechanism of claim 1, wherein the electronic device is a cordless, optical mouse.

3. The power saving mechanism of claim 1, wherein the electronic device is a cordless mouse.

4. The power saving mechanism of claim 1, wherein the vibration sensor is a mercury switch.

5. A power saving mechanism for a cordless electronic device comprising:
a vibration sensor located on a circuit board of the electronic device, the vibration sensor having one end electrically coupled to an input pin of a microprocessor on the circuit board and a power supply of the circuit board respectively and the other end being ground so that current of the power supply is supplied to the input pin for maintaining the input pin at a predetermined logic level;
wherein, after a predetermined period of inactivity of the electronic device and open condition of the vibration sensor, the electronic device enters into a power saving mode and is inactive; while the electronic device is vibrated, the vibration sensor is closed for causing the electronic device to enter into an operating mode, in response, the current of the power supply is diverted to supply to the ground via the vibration sensor to activate the microprocessor for changing its logic level for activation, and thereby activate all electronic components of the circuit board to enter into an operating mode.

6. The power saving mechanism of claim 5, wherein the electronic device is a cordless, optical mouse.

7. The power saving mechanism of claim 5, wherein the electronic device is a cordless mouse.

8. The power saving mechanism of claim 5, wherein the vibration sensor is a mercury switch.
